(19) United States
(12) Patent Application Publication
(10) Pub. No.: US 2003/0009660 A1
(43) Pub. Date: Jan. 9, 2003

(54) Method and ystem for establishing and bridging of semi-private peer networks

(76) Inventor: Mark R. Walker, Beaverton, OR (US)

Correspondence Address: PILLSBURY WINTHROP, LLP, P.O. BOX 10500, MCLEAN, VA, 22102, US

(21) Appl. No.: 09/899,837

(22) Filed: Jul. 9, 2001

(51) Int. Cl. H04L 9/00

(52) U.S. Cl. 713/153

(57) ABSTRACT

A method and system for establishing and bridging semi-private peer networks is provided. According to an embodiment of the invention, there is provided a method, member peer node and computer program product to establish a semi-private peer network using encrypted or otherwise obfuscated keys and a connection list identifying members of the semi-private peer network defined by an organizing entity. According to another embodiment of the invention, a method for spanning and a bridging agent with the ability to span information requests and/or queries between multiple, semi-private peer or other networks is disclosed.

### BACKGROUND

1. Field of the Invention

This invention relates in general to the field of peer networks. Particularly, aspects of this invention pertain to bridging semi-private peer networks.

2. General Background and Related Art

Current popular ‘peer network’—central server-independent, peer-to-peer file sharing—protocols such as employed by Gnutella software applications permit users of Internet-connected computers to search for and share files without the involvement of a central server computer. These schemes employ publicly documented connection protocols and binary packet formats that allow virtually anyone to participate in a peer network. Applications based on these protocols have been advancing as the number of ‘always-connected’ digital subscriber line (DSL) and cable modem connected computers have increased to expand the size, bandwith and scope of the peer network.

Referring to FIG. 1, a node 100 comprising a peer network software application 105 constructed around a peer network protocol is connected to a peer network wherein the peer nodes communicate with each other according to this protocol. The peer network software application typically comprises a user interface that includes a text box in which strings or other text fragments corresponding to file names are entered for searching among the other peer nodes connected to the peer network at the time of the search. Once a search query is entered, the query is packaged into a standard, binary packet form by the peer network software application and forwarded to all transmission control protocol/Internet protocol (TCP/IP) addresses, each corresponding to a peer node in the peer network, appearing on a local, dynamically updated list 110 of such addresses. All peer nodes 115, 120 on the list that are connected to the peer network at search time receive the query packet. Those peer nodes may attempt to match the query string with descriptions of files contained in their own local databases 125, 130. The query may be forwarded further by each receiving node to its own local list of peer nodes 135, 140 that will attempt to match the query string with descriptions of files contained in their own local databases 145, 150. If a given peer node detects a match, a reply string is packaged into a standard, binary packet form according to the peer network protocol and returned to the requesting node. The requesting node receives the results of the search in the form of a list of file names or file content descriptions that match the query string along with their TCP/IP locations. The requesting peer node may then elect to download some or all of the files from its peer network location using HTTP or some other network protocol.

Current peer network schemes incur a number of disadvantages. One such disadvantage is that current peer networks allow participation by unmotivated and misbehaving users. For example, these users may usurp the intended use of the peer network by sending unsolicited advertisements or other spam to the other connected peers in response to requests and/or queries. Other users may superficially appear to be exchanging files and messages in an appropriate way, but may actually be sharing files that are empty or are labeled with deliberately misleading names. Some users may only use the peer network for obtaining files without also offering files for sharing. Behaviors of this type can greatly diminish the usefulness of a peer network for compliant users who may even be relying on the peer network to support small business activity.

Another disadvantage is that current peer networks allow almost anyone to connect. All-encompassing peer networks could be subject to potentially unmanageably high levels of packet traffic. Moreover, by allowing almost anyone to connect, the focus of a peer network can become diffused and privacy of any sort cannot be maintained. Instead, establishing a peer network to maintain a narrow focus and yet still receive minimal traffic outside of the focus of such a peer network would tend to minimize traffic on that peer network and thus enhance the usefulness and the privacy of any application built on top of that peer network.

Accordingly, there is a need for improved usefulness of peer networks by establishing a certain type of peer network that will be increasingly employed by motivated users and will thus become generally more useful and less prone to mischief. Further, it would be advantageous to provide improved focus and privacy within peer networks so as to promote, for example, the development of business peer networks, including business-to-business peer networks, and limit concerns of high peer network traffic. Indeed, peer networks with improved focus and privacy could promote a new class of central server-free software applications based upon controlled network access such as a peer network designed to connect a group of particular buyers and sellers. Therefore, it would be advantageous to provide a method and system for establishing semi-private peer networks and bridging those semi-private peer networks.

### BRIEF DESCRIPTION OF THE DRAWINGS

Exemplary embodiments of the invention are illustrated in the accompanying drawings in which like references indicate similar or corresponding elements and in which:

FIG. 1 is a high-level block diagram of the architecture of a peer network;

FIG. 2 is a high-level block diagram of the architecture of a semi-private peer network according to an embodiment of the invention;

FIG. 3(a)-(c) is a flow diagram illustrating a method for establishing a semiprivate peer network according to an embodiment of the invention; and

FIG. 4(a)-(c) is a flow diagram illustrating a method for bridging semi-private peer or other networks according to an embodiment of the invention.

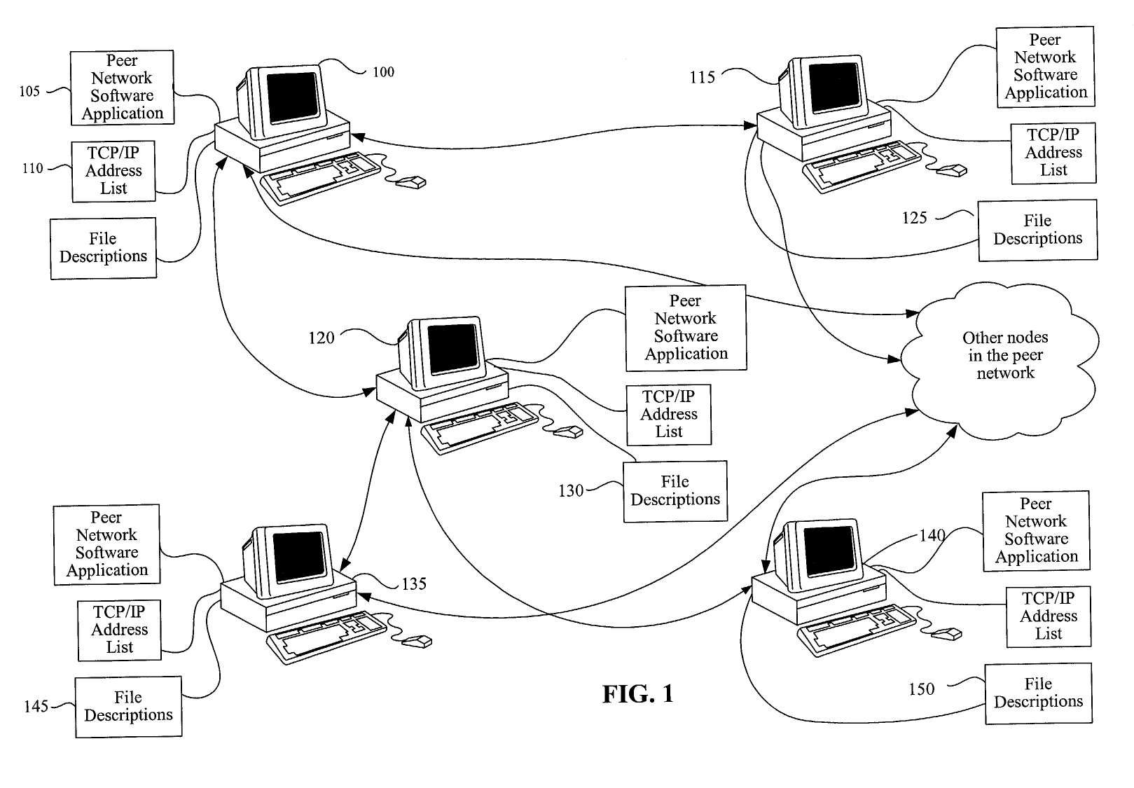

### DETAILED DESCRIPTION

A method and system for establishing and bridging semi-private peer networks is provided. According to an embodiment of the invention, there is provided a method, member peer node and computer program product to establish a semi-private peer network using encrypted or otherwise obfuscated keys and a connection list identifying members of the semi-private peer network defined by an organizing entity. According to another embodiment of the invention, a method for spanning and a bridging agent with the ability to span information requests and/or queries between multiple, semi-private peer or other networks is disclosed.

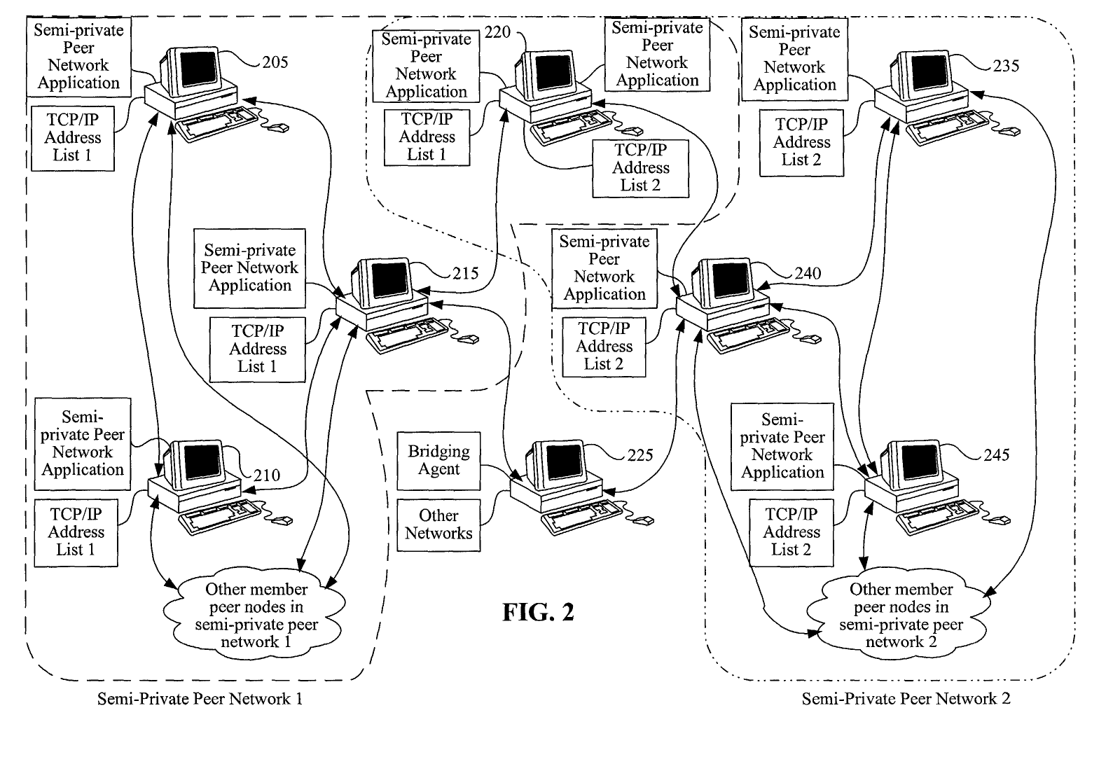

Referring to FIG. 2, a high-level block diagram of the architecture of two semi-private peer networks according to an embodiment of the invention is depicted. Semi-private peer network 1 200 comprises a number of member peer nodes 205, 210, 215, 220 connected to each other directly or indirectly. Semi-private peer network 2 230 comprises a number of member peer nodes 220, 235, 240, 245 connected to each other directly or indirectly. Each member peer node comprises a semi-private peer network application as well as a connection list of TCP/IP addresses related to that semi-private peer network as further described hereafter. As will be further discussed below, a member peer node 220 may be connected to two or more semi-private peer networks by, for example, having two semi-private peer network applications operate on the member peer node using two connections lists of TCP/IP addresses, one applicable to each semi-private peer network. In an embodiment, the semi-private peer network may be distributed with nodes in disparate physical locations and/or organizations although as will be apparent to those skilled in the art a semi-private peer network need not be so distributed.

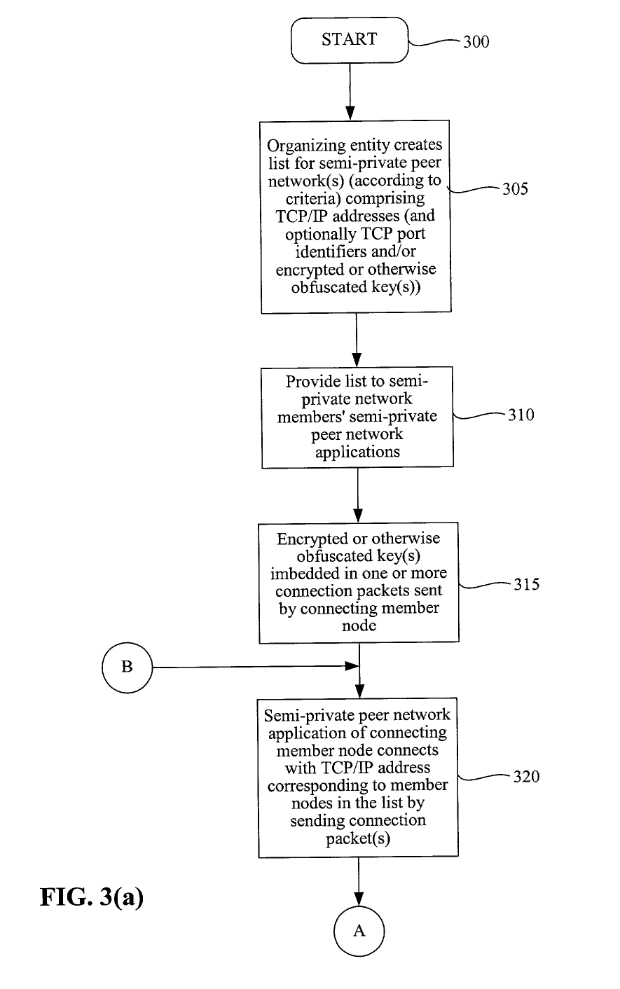

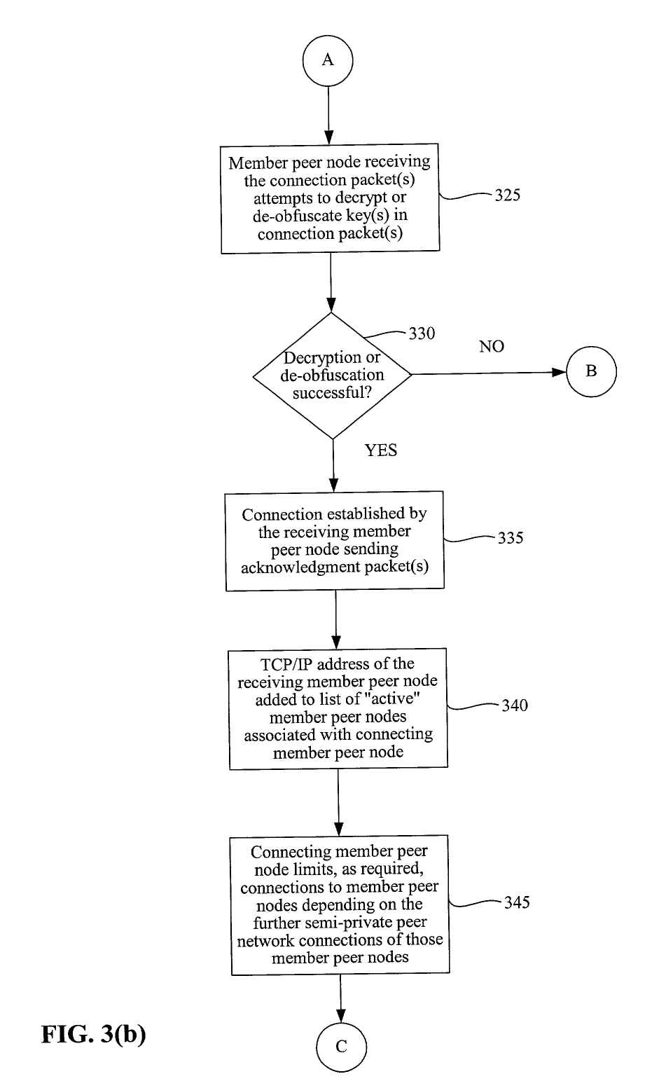

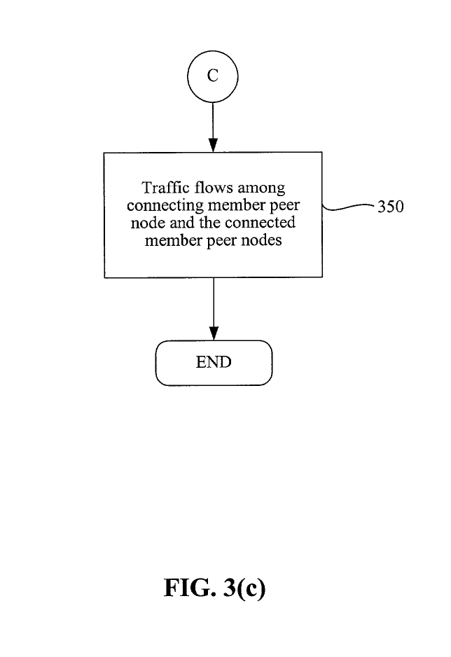

Referring to FIG. 3(a)-(c), a flow diagram illustrating a method for establishing a semi-private peer network such as shown in FIG. 2 according to an embodiment of the invention is depicted. To establish a semi-private peer network, an organizing entity creates (and perhaps subsequently maintains) one or more connection lists of TCP/IP addresses, and optionally TCP port identifiers used to designate the port on the respective member peer node used for handling all or particular semi-private peer network traffic and/or encrypted or otherwise obfuscated key(s) (as described in more detail below), that are associated with designated members of one or more semi-private peer networks 305, each connection list of TCP/IP addresses (and optionally TCP port identifiers) corresponding to a semi-private peer network and each TCP/IP address corresponding to a member peer node in the semi-private peer network to which the connection list is related. As will be apparent to those skilled in the art, other addressing and port schemes now or hereafter known may be used instead of TCP/IP addresses and TCP ports.

An organizing entity may be, for example, any person, company, partnership, association or simply a device that defines the semi-private peer network(s) by identifying the members of the semi-private peer network and the TCP/IP addresses associated with those members' peer nodes to be included on the connection list(s) of TCP/IP addresses (and optionally TCP port identifiers and/or encrypted or otherwise obfuscated key(s)). Member identification information may also be added to the connection list(s) (and so shared with the other members of the semi-private peer network) or instead member identification information may be retained by the organizing entity and not shared with the other members of the semi-private peer network.

The organizing entity may elect to set criteria for members selection and for inclusion of selected members in one or more semi-private peer networks by adding the members' TCP/IP addresses into a connection list of TCP/IP addresses (and optionally TCP port identifiers and/or encrypted or otherwise obfuscated key(s)) for each such semi-private peer network. Criteria may include fee payment, common bond such as a common interest or objective, length of association with an organizing entity, etc. Members may be, for example, persons, companies, partnerships, associations or devices. A member need not necessarily join a semi-private peer network voluntarily; a member may be included, for example, automatically simply by meeting certain criteria. A semi-private peer network also need not necessarily comprise a finite group of members. Through the use of criteria, semi-private peer networks dedicated to, for example, specific buying and selling activities but with unlimited membership can be established.

Each member (or designate) has a semi-private peer network application for connecting to one or more semi-private peer networks using a specially configured peer network protocol designed as described herein or a peer network protocol now or hereafter known that is modified to operate as described herein. In an embodiment, such a semi-private peer network application comprises software to establish a member peer node on a member's device, which is capable of sharing as well as obtaining files and information from other member peer nodes on the semi-private peer network, and is provided 310 the connection list(s) of TCP/IP addresses (and optionally TCP port identifiers and/or encrypted or otherwise obfuscated key(s)) related to the semi-private peer network(s) in which the member has been included. In an embodiment, the organization may supply the semi-private peer network application for installation on the member device and/or may offer updates to the connection list of TCP/IP addresses (and optionally TCP port identifiers and/or encrypted or otherwise obfuscated key(s)).

When attempting to establish a connection to a desired semi-private peer network, the semi-private peer network application of a member attempts to connect with as many as possible of the active TCP/IP addresses on the member peer node's connection list(s) of TCP/IP addresses associated with the desired semi-private peer network 320. Where a TCP port identifier is provided in the connection list, the TCP port identifier may also be used in connecting to the member peer nodes represented by the TCP/IP addresses on the connection list, particularly as discussed below where a member peer node makes a connection to multiple semi-private peer networks. Connection is typically established by sending one or more connection packets, according to the peer network protocol of the semi-private peer network, from the connecting member peer node to each of the TCP/IP addresses (and optionally TCP ports) on the member peer node's connection list. If connection is permitted and/or validated by the receiving member peer nodes to which connection packets have been sent, one or more acknowledgment packets are returned by the receiving member peer nodes, corresponding to the TCP/IP addresses, on the semi-private peer network to the connecting member peer node in order to establish a connection. The number of active member peer nodes actually connected to by the connecting member peer node may be limited to some number (e.g. less than ten) without compromising application performance. Further, the semi-private peer network application may limit connections to one or more certain member peer nodes by determining whether such member peer node is not connected to the same set of member peer nodes as another already connected member peer node 345. If so, a connection to such member peer node(s) may not be made or may be terminated because of the redundancy of connections.

To further facilitate the establishment of the semi-private peer network, the one or more connection packets include an encrypted or otherwise obfuscated key imbedded within the packet(s) 315. The encrypted or otherwise obfuscated key(s) is provided exclusively, whether in gross or individually, to the designated members of the semi-private peer network so that the semi-private nature of the semi-private peer network may be maintained by controlling access to that network using that key. To that end, the encryption or other obfuscation of the key is used to prevent or at least limit use of the key by others. Similarly, providing individual keys for each member of a semi-private peer network versus a key applicable to all members provides, in addition to greater granularity for adding and removing members, enhanced control of the semi-private nature of the semi-private peer network through member key validation. While this current scheme is designed to provide a semi-private peer network relatively free of non-compliant usage, it may be extended or enhanced to provide not only private but secure peer networks. Any known techniques or algorithms for encryption or obfuscation may be used such as public key cryptography, translation table cryptography, etc.

As will be apparent to those skilled in the art, the key(s) may be added to other transmission packets besides connection packets to provide greater protection of the semi-private nature of the semi-private peer network. The connection packet(s) may also contain further information such as the TCP/IP address of the connecting member peer node as well as a TCP port identifier of the connecting member peer node for receiving all or particular semi-private peer network traffic.

The key(s) may be supplied as part of the connection list of TCP/IP addresses (and optional TCP port identifiers), may be separately supplied individually or as a list for use by a semi-private peer network application, or may be integrated into the semi-private peer network application. As indicated above, the key(s) may be individually customized per member peer node or may be applicable to all member peer nodes in gross. Updates to the key(s) and/or the encryption or other obfuscation of the key(s), if necessary, may be supplied manually (e.g. by e-mail) or automatically (e.g. by automated download) as required or from time to time by the organizing entity, or any other entity entrusted with the key and/or the encryption or other obfuscation update, to the member peer nodes, for example, through the connection list of TCP/IP addresses (and optional identifiers) or to the semi-private peer network application individually or as a list. Through the updating mechanism, ‘lapsed’ members may be removed from the semi-private peer network as well as to some extent the privacy of the semi-private peer network maintained either by explicitly removing the key(s) for a member or through the inability of a member to connect to the semi-private peer network because the key and/or encryption or other obfuscation is out-of-date.

Each operating member peer node receiving the connection packet(s) attempts to decrypt or de-obfuscate the imbedded key 325. To decrypt the key, the semi-private peer network application may use, for example, a public key to decrypt the imbedded key encrypted with a matching private key (to the public key) associated with the organizing entity and/or the member. Such a public key may be associated with the semi-private peer network application or be otherwise provided (e.g. through a public key server) and, as described above, such public key may be manually or automatically updated as required or from time to time. Similarly, the imbedded key may simply be encrypted/decrypted with a single key whether the key is associated with a particular member's semi-private peer network application or with all semi-private peer network applications. Furthermore, the imbedded key may be obfuscated according to a particular algorithm and may be de-obfuscated by a semi-private peer network application using the same or complementary algorithm.

If the imbedded key is successfully decrypted or de-obfuscated 330 by a member peer node, the TCP/IP address of the connecting member peer node is added to a dynamic list of ‘active’ member peer nodes associated with that member peer node 340 and a connection is thereby established with the connecting member peer node (as described above, e.g., by sending one or more acknowledgment packets to the connecting member peer node) 335. Consequently, each member peer node that successfully decrypts or de-obfuscates the imbedded key sent by a connecting member peer node will list that connecting member peer node in its own list of ‘active’ member peer nodes. Similarly, the connecting member peer node may maintain a list of ‘active’ member peer nodes with which it has made connections either by successfully decrypting or de-obfuscating a key sent by another connecting member peer node(s) or by successfully establishing a connection with one or more member peer nodes to which it has sent an encrypted or otherwise obfuscated key. The list of ‘active’ member peer nodes may be used with the connection limiting feature described above to determine whether a member peer node is not connected to the same set of member peer nodes as another already connected member peer node 345.

Once a connection is established between a connecting member peer node and one or more other member peer nodes in the semi-private peer network, traffic to and from the connecting member peer node with the other member peer nodes in the semi-private peer network may be initiated 350. That is, each successfully connected peer node then initiates, forwards and responds to requests and/or queries from other member peer nodes on the semi-private peer network. As should be apparent, a connecting member peer node need not be directly connected to every member peer node in the semi-private peer network in order for traffic to reach such member peer nodes not directly connected to by the connecting member peer node; rather, traffic to and from such “unconnected” member peer nodes may reach those “unconnected” member peer nodes or the connecting member peer node, as the case may be, indirectly through member peer nodes to which the connecting member peer node is actually connected. For this reason, the scope of the semi-private peer network of a connecting member peer node is not necessarily defined by the particular connection list of TCP/IP addresses of the semi-private peer network application of the connecting member peer node.

Through the use of the optional TCP port identifier of the connection list of TCP/IP addresses, a member may participate in multiple semi-private peer networks. Particularly, since each semi-private peer network application may be exclusively associated with one or more TCP ports on a given member peer node, multiple semi-private peer network applications may be executed simultaneously on a given member peer node (or alternatively a single semi-private peer network application may be able to handle traffic on multiple TCP ports) to establish multiple semi-private peer networks. So, by using TCP port identifiers, a member may be able to join and communicate on multiple different semi-private peer networks.

Optionally, specialized information may be defined in the peer network protocol used by semi-private peer network applications as described herein to facilitate specific semi-private peer networks. For example, the packet protocol of the peer network protocol of a semi-private peer network dedicated to buying and selling securities may be adapted to include fields for security descriptions as well as bid, offer and other trade information and/or to provide special packets for securities offers and bids.

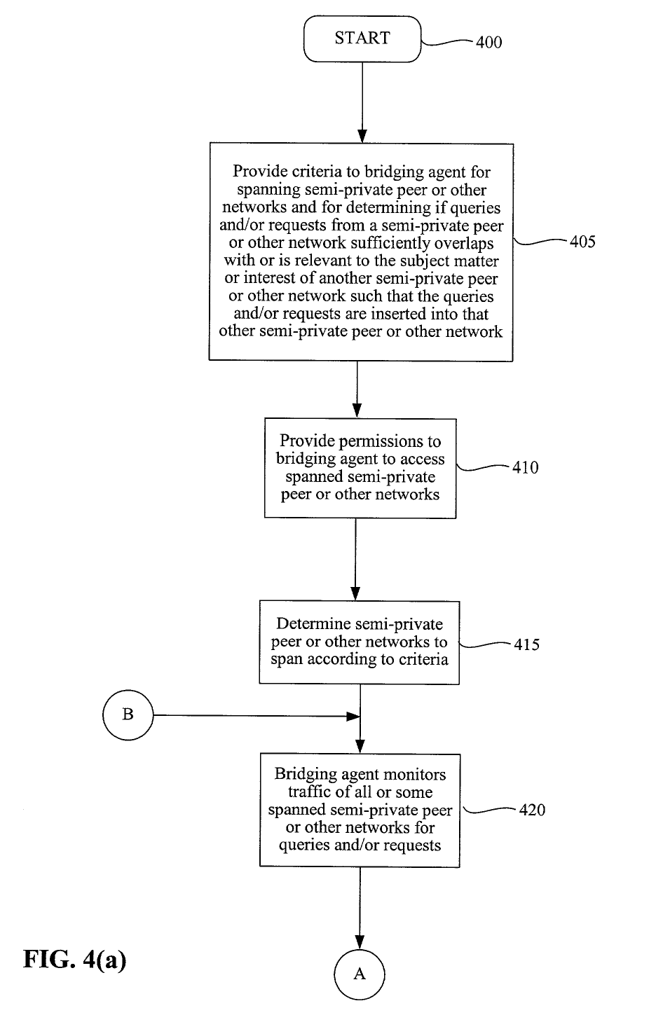

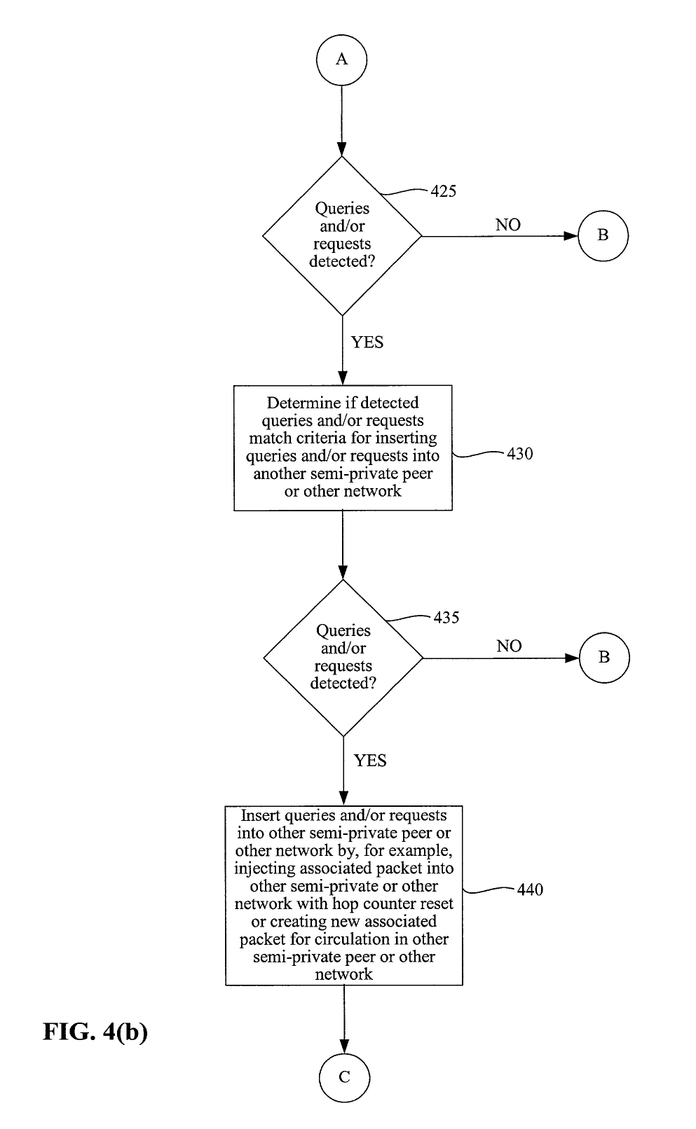

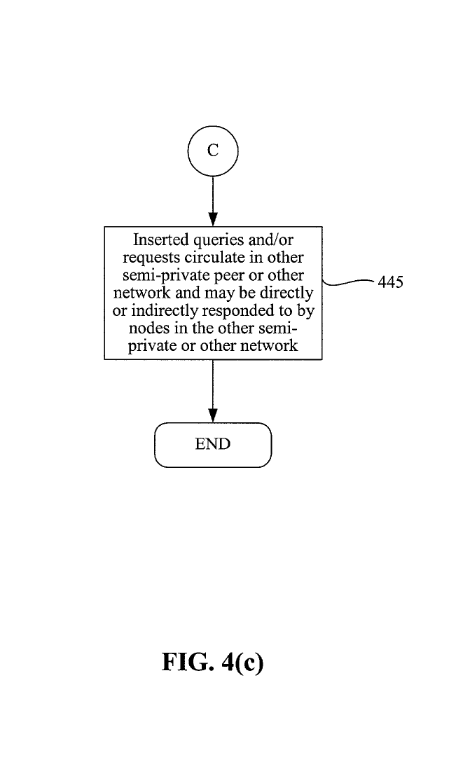

Referring to FIG. 4(a)-(c), a flow diagram illustrating a method for bridging semi-private peer or other networks such as shown in FIG. 2 according to an embodiment of the invention is depicted. To bridge a semi-private peer network to another network, a bridging agent is provided that includes an examination unit that examines the requests and/or queries circulating within the semi-private peer and/or another network and an insertion unit that then inserts some or all of those requests and/or queries within the semi-private peer network into the another network and/or inserts some or all of those requests and/or queries within the another network into the semi-private network, when the requests and/or queries are determined appropriate by the bridging agent for circulation within the another network and/or semi-private peer network respectively. As used herein other networks include any other type of network including, for example, other semi-private peer networks or other traditional peer networks that are not semi-private. So, by providing such a bridging agent to span requests and/or queries between different semi-private peer or other networks, each semi-private peer network may be able to better maintain a common interest focus while maintaining access/connection to any number of completely different other networks with perhaps different subject matter or interest focuses.

Referring to FIG. 2, an example application of the bridging agent is depicted in the context of two semi-private peer networks. Semi-private peer network 1 200 comprises, for example, members involved in selling and collecting early American antiques. Semi-private peer network 2 230 comprises, for example, a completely (but not necessarily required) different group of members involved in selling and collecting antique guns. Bridging node 225 comprises a bridging agent to connect (as described in more detail below) semi-private peer network 1 and semi-private peer network 2. As should be apparent, a bridging node/agent may bridge a semi-private peer network to other networks such as traditional peer networks and a bridging node may be a member peer node of one or both semi-private peer networks. Further, more than one bridging node/agent may be employed between a semi-private peer network and other networks.

Referring to FIG. 4(a)-(c), in an embodiment, the bridging agent is provided criteria for spanning two or more semi-private peer or other networks and the criteria is used by the bridging agent to determine which semi-private peer or other networks should be spanned 405. More particularly, an organizing or other entity with high-level knowledge of the subject matter or interest focus of semi-private peer or other networks of interest defines some high-level criteria for determining which semi-private peer or other networks the bridging agent should monitor and determining between which semi-private peer or other networks requests and/or queries should be allowed to jump. For example, the criteria may define that the bridging agent should monitor semi-private peer network 1 and semi-private peer network 2 for search queries and that all or some types of search queries from each or just one semi-private peer network may be inserted into the other semi-private peer network. The criteria for query and/or request spanning between semi-private peer or other networks by the bridging agent may be logical expressions, text tables, an artificial intelligence program with natural language capability, or by any other common means of programmatically generating decisions associated with the bridging agent.

Additionally, in order to monitor queries and/or requests in the semi-private peer or other networks, the bridging agent is configured with permission to access the to be monitored semi-private peer or other networks 410. In an embodiment, the bridging agent receives member status within both semi-private peer network 1 and semi-private peer network 2 so as to allow it full permission to monitor, initiate and respond to queries and/or requests in those semi-private peer networks. In the embodiment described earlier, the bridging agent may be provided encrypted or otherwise obfuscated keys to both semi-private peer network 1 and semi-private peer network 2 which it can then use in establishing a connection to one or more member peer nodes in each of semi-private peer network 1 and semi-private peer network 2.

When activated, the bridging agent(s) determines the semi-private peer or other network to span (and connects to them) 415 and then monitors the requests and/or queries on some or all spanned semi-private peer or other networks to which it is connected 420. In an embodiment, the bridging agent is software configured to continuously monitor packet traffic of semi-private peer network 1 and semi-private peer network 2 for search queries. As will be apparent to those skilled in the art, the bridging agent could monitor for other types of requests or queries in place of or in addition to search queries.

When one or more queries and/or requests are detected 425, the bridging agent, which is provided more high-level criteria, examines and determines if the requests and/or queries from one semi-private peer or other network comprise information that sufficiently overlaps with or is relevant to the subject matter or interest of another semi-private peer or other network such that the queries and/or requests are inserted into the other semi-private peer or other network 430. For example, the bridging agent may detect a search query in semi-private peer network I initiated by a member seeking to buy a Civil War era rifle. The bridging agent would examine the search query information about the Civil War era rifle and determine based upon some or all of that information, e.g. age information associated with the Civil war era rifle query information, whether the search query should be inserted into semi-private peer network 2. In another embodiment, all search queries from either semi-private peer or other network may automatically be inserted into the other semi-private peer or other network. Like the criteria for spanning between semi-private peer or other networks, the criteria for inserting a query and/or request from one semi-private peer or other network into another semi-private peer or other network by the bridging agent may be logical expressions, text tables, an artificial intelligence program with natural language capability, or by any other common means of programmatically generating decisions associated with the bridging agent.

If the above criteria are satisfied with respect to one or more queries and/or requests from a semi-private peer or other network 435, the bridging agent inserts the queries and/or requests into the other relevant semi-private peer or other network 440. For example, if the criteria are satisfied for the insertion of a search query from semi-private peer network 1 into semi-private peer network 2, the bridging agent copies the packet associated with the search query from semi-private peer network 1, injects it into semi-private peer network 2 and resets the hop counter associated with that packet. A hop counter is a common counter feature of peer networks that is maintained within a packet to determine the maximum number of times the packet may forwarded from node to node within the peer network in order to prevent the packet from circulating infinitely within the peer network. In practice, each forwarding event associated with the packet causes that packet's hop counter to be decremented. When the hop counter reaches zero, that packet is no longer forwarded. Accordingly, when the hop counter is reset, the maximum number of forwarding events is reset into the packet's hop counter. In other embodiments, the hop counter may still be used to determine the maximum number of times the packet may be forwarded but instead the hop counter is incremented and the hop counter is reset to zero or some other value. The bridging agent may also alter the copied search query packet, particularly any search information, to better align the search query with the subject mater or interest of semi-private peer network 2.

In an other exemplary embodiment, if the criteria are satisfied for the insertion of a search query from semi-private peer network 1 into semi-private peer network 2, the bridging agent creates a new packet for the semi-private peer network 2 corresponding to the search query packet of semi-private peer network 1. For example, a new search query packet may be created for circulation in semi-private peer network 2 that incorporates all or some of the query information, including the search parameter(s) and the TCP/IP address (and perhaps the listening TCP port identifier) of the originating member peer node, from the search query packet of semi-private peer network 1. Such an embodiment is useful for example where the two semi-private peer networks operate according to different peer network protocols in which case additional information may be added to the new search query packet to signify the different peer network protocols used on the semi-private peer networks.

Once the bridging agent inserts queries and/or requests into the other semi-private peer or other network, the queries and/or requests circulate in that other semi-private peer or other network as normal queries and/or requests and may be responded to by nodes in that semi-private peer or other network as normal queries and/or requests 445. For example, where the packet associated with a search query is copied into semi-private peer network 2, a member peer node in semi-private peer network 2 may respond to and subsequently transact directly with the originating member peer node in semi-private peer network 1 without being aware that the query originated within another semi-private peer network by using the TCP/IP address (and perhaps the listening TCP port identifier) of the originating member peer node contained in the copied packet. In the case where a new packet was created for semi-private peer network 2 and the semi-private peer network 1 operates on a different peer network protocol than semi-private peer network 2, the semi-private peer network application of semi-private peer network 2 may recognize information in the new packet indicating a different peer network protocol is used by the originating member peer node and so transact directly, or indirectly through the bridging agent, with the originating member peer node using that node's peer network protocol.

The detailed descriptions may have been presented in terms of program procedures executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the invention is not limiting of the invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the invention based on the description herein with only a reasonable effort and without undue experimentation.

A procedure is here, and generally, conceived to be a self-consistent sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations of the invention described herein; the operations are machine operations. Useful machines for performing the operations of the invention include general purpose digital computers, special purpose computers or similar devices.

Each operation of the method may be executed on any general computer, such as a mainframe computer, personal computer or the like and pursuant to one or more, or a part of one or more, program modules or objects generated from any programming language, such as C++, Java, Fortran, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a microprocessor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations described herein without departing from the spirit of the invention. For instance, in certain cases, the operations may be performed in differing order, or operations may be added, deleted or modified. An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

While this invention has been described in relation to certain embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention Changes, including equivalent structures, acts, materials, etc., may be made, within the purview of the appended claims, without departing from the scope and spirit of the invention in its aspects. Thus, it should be understood that the above described embodiments have been provided by way of example rather than as a limitation of the invention and that the specification and drawing(s) are, accordingly, to be regarded in an illustrative rather than a restrictive sense. As such, the invention is not intended to be limited to the embodiments shown above but rather is to be accorded the widest scope consistent with the principles and novel features disclosed in any fashion herein.

What is claimed:

1. A method for creating a semi-private peer network, comprising:
in attempting to connect to one or more member peer nodes corresponding to one or more addresses on a connection list of addresses corresponding to member peer nodes of the semi-private peer network, sending an encrypted or otherwise obfuscated key from a connecting member peer node of the semi-private peer network to the one or more member peer nodes; and
establishing a connection between the connecting member peer node and the one or more member peer nodes that successfully decrypt or de-obfuscate the encrypted or otherwise encrypted key.

2. The method of claim 1, wherein addresses are TCP/IP addresses, sending an encrypted or otherwise obfuscated key comprises sending a packet with the encrypted or otherwise obfuscated key and establishing a connection comprises establishing a connection upon receiving an acknowledgement from the one or more member peer nodes that successfully decrypt or de-obfuscate the encrypted or otherwise encrypted key.

3. The method of claim 2, wherein the connection list further includes TCP port identifiers associated with the TCP/IP addresses, to designate the port on which a member peer node corresponding to a TCP/IP address handles semi-private network traffic and sending a packet comprises sending a packet to the one or more TCP ports associated with the one or more member peer nodes.

4. The method of claim 1, wherein the connection list further includes one or more encrypted or otherwise obfuscated keys associated with the one or more addresses on the connection list.

5. The method of claim 1, wherein establishing a connection comprises limiting establishing a connection to the one or more member peer nodes that are not connected to a same set of member peer nodes as an already connected member peer node.

6. A computer program product including computer program code to cause a microprocessor to perform a method for creating a semi-private peer network, the method comprising:
in attempting to connect to one or more member peer nodes corresponding to one or more addresses on a connection list of addresses corresponding to member peer nodes of the semi-private peer network, sending an encrypted or otherwise obfuscated key from a connecting member peer node of the semi-private peer network to the one or more member peer nodes; and
establishing a connection between the connecting member peer node and the one or more member peer nodes that successfully decrypt or de-obfuscate the encrypted or otherwise encrypted key.

7. The computer program product of claim 6, wherein addresses are TCP/IP addresses, sending an encrypted or otherwise obfuscated key comprises sending a packet with the encrypted or otherwise obfuscated key and establishing a connection comprises establishing a connection upon receiving an acknowledgement from the one or more member peer nodes that successfully decrypt or de-obfuscate the encrypted or otherwise encrypted key.

8. The computer program product of claim 7, wherein the connection list further includes TCP port identifiers associated with the TCP/IP addresses, to designate the port on which a member peer node corresponding to a TCP/IP address handles semi-private network traffic and sending a packet comprises sending a packet to the one or more TCP ports associated with the one or more member peer nodes.

9. The computer program product of claim 6, wherein the connection list further includes one or more encrypted or otherwise obfuscated keys associated with the one or more addresses on the connection list.

10. The computer program product of claim 6, wherein establishing a connection comprises limiting establishing a connection to the one or more member peer nodes that are not connected to a same set of member peer nodes as an already connected member peer node.

11. A member peer node of a semi-private network, comprising:
a connection list of addresses corresponding to member peer nodes of the semi-private peer network; and
a semi-private peer network application to, in attempting to connect to one or more member peer nodes corresponding to one or more addresses of the connection list, send an encrypted or otherwise obfuscated key to the one or more member peer nodes for decryption or de-obfuscation by the one or more member peer nodes, and to decrypt or de-obfuscate an encrypted or otherwise obfuscated key sent by one or more member peer nodes of the semi-private peer network attempting to connect with the member peer nodes.

12. The member peer node of claim 11, wherein addresses are TCP/IP addresses, sending an encrypted or otherwise obfuscated key comprises sending a packet with the encrypted or otherwise obfuscated key and establishing a connection comprises establishing a connection upon receiving an acknowledgement from the one or more member peer nodes that successfully decrypt or de-obfuscate the encrypted or otherwise encrypted key.

13. The member peer node of claim 12, wherein the connection list further includes TCP port identifiers associated with the TCP/IP addresses, to designate the port on which a member peer node corresponding to a TCP/IP address handles semi-private network traffic and sending a packet comprises sending a packet to the one or more TCP ports associated with the one or more member peer nodes.

14. The member peer node of claim 12, wherein the connection list further includes one or more encrypted or otherwise obfuscated keys associated with the one or more addresses on the connection list.

15. A bridging agent for connecting a semi-private peer network to another network, comprising:
an examination unit that examines requests and/or queries circulating within the semi-private peer network and/or another network; and
an insertion unit that inserts one or more of the requests and/or queries within the semi-private peer network into the another network and/or inserts one or more of the requests and/or queries within the another network into the semi-private network, when the requests and/or queries are determined appropriate by the bridging agent for circulation within the another network and/or semi-private peer network respectively.

16. The bridging agent of claim 15, wherein the another network is another semi-private peer network.

17. The bridging agent of claim 15, wherein the bridging agent has a member status within the semi-private peer network and the another network so as to allow the bridging agent permission to monitor, initiate and respond to request and/or queries in the semi-private peer network and/or another network.

18. The bridging agent of claim 15, wherein the requests and/or queries are determined appropriate for circulation within the another network and/or semi-private peer network through the use of high-level criteria to assess if the requests and/or queries comprise information that sufficiently overlaps with or is relevant to the subject matter or interest of the semi-private peer network and/or another network.

19. The bridging agent of claim 15, wherein inserting one or more requests and/or queries comprises copying one or more packets associated with the one or more requests and/or queries and injecting the one or more packets into the semi-private network and/or another network to which the one or more requests and/or queries are inserted.

20. The bridging agent of claim 15, wherein inserting one or more requests and/or queries comprises creating one or more new packets corresponding to the one or more requests and/or queries and circulating the one or more new packets into the semi-private network and/or another network to which the one or more requests and/or queries are inserted.

21. A method for bridging a semi-private peer network to another network, comprising:
examining requests and/or queries circulating within the semi-private peer network and/or another network; and
inserting one or more of the requests and/or queries within the semi-private peer network into the another network and/or inserting one or more of the requests and/or queries within the another network into the semi-private network, when the requests and/or queries are determined appropriate by the bridging agent for circulation within the another network and/or semi-private peer network respectively.

22. The bridging agent of claim 21, wherein the another network is another semi-private peer network.

23. The bridging agent of claim 21, wherein examining the requests and/or queries comprises having a member status within the semi-private peer network and the another network so as to allow for monitoring, initiating and responding to request and/or queries in the semi-private peer network and/or another network.

24. The bridging agent of claim 21, wherein the requests and/or queries are determined appropriate for circulation within the another network and/or semi-private peer network through the use of high-level criteria to assess if the requests and/or queries comprise information that sufficiently overlaps with or is relevant to the subject matter or interest of the semi-private peer network and/or another network.

25. The bridging agent of claim 21, wherein inserting one or more requests and/or queries comprises copying one or more packets associated with the one or more requests and/or queries and injecting the one or more packets into the semi-private network and/or another network to which the one or more requests and/or queries are inserted.

26. The bridging agent of claim 21, wherein inserting one or more requests and/or queries comprises creating one or more new packets corresponding to the one or more requests and/or queries and circulating the one or more new packets into the semi-private network and/or another network to which the one or more requests and/or queries are inserted.
